(19) United States
(12) Patent Application Publication
(10) Pub. No.: US 2013/0346120 A1
(43) Pub. Date: Dec. 26, 2013

(54) INFORMATION PROVIDING DEVICE AND INFORMATION PROVIDING METHOD

(71) Applicant: YAHOO JAPAN CORPORATION, Tokyo (JP)

(72) Inventors: Itaru Kurisu, Tokyo (JP); Kenji Inaba, Tokyo (JP)

(21) Appl. No.: 13/920,362

(22) Filed: Jun. 18, 2013

(30) Foreign Application Priority Data
Jun. 21, 2012 (JP) 2012-139688

(51) Int. Cl. G06Q 10/02

(52) U.S. Cl. CPC G06Q 10/02
USPC 705/5

(57) ABSTRACT

An information providing device according to an embodiment includes a user information storing unit that stores, every user, user information and destination information related to a user in association with each other, a determining unit that determines a user corresponding to user information having a specific relation with a cancellation object in the user information storing unit as a user to which the cancellation object is recommended, and a transmitting unit that acquires destination information on the user determined by the determining unit from the user information storing unit, and transmits the information on the cancellation object to a destination according to the destination information.

### CROSS-REFERENCE TO RELATED APPLICATION

The present application claims priority to and incorporates by reference the entire contents of Japanese Patent Application No. 2012-139688 filed in Japan on Jun. 21, 2012.

### BACKGROUND OF THE INVENTION

1. Field of the Invention

The present invention relates to an information providing device and an information providing method.

2. Description of the Related Art

In recent years, with the development of a network represented by the Internet, it has become possible to make a reservation of various products or services such as a travel reservation, a restaurant or hair salon reservation, a concert or flight ticket reservation, and a new product reservation from a terminal device via a network.

A reservation of a product or a service using a network can be made, for example, by a terminal device accessing a reservation site. Further, many reservation sites allow a reservation to be cancelled. However, for example, when many reservations are cancelled or when a cancellation is made at the last minute, a product or a service may not be appropriately provided.

In this regard, there has been proposed a system in which waiting for a cancellation can be set, and when a cancellation is made, an application of the waiting for a cancellation is accepted (for example, see Japanese Laid-open Patent Publication No-2002-197226).

However, in the system disclosed in Japanese Laid-open Patent Publication No. 2002-197226, when waiting for a cancellation is not set, since an application for a cancellation is not accepted, there is a concern that a product or a service may not be appropriately provided.

### SUMMARY OF THE INVENTION

According to one aspect of the embodiments, an information providing device includes an information acquiring unit that acquires information on a cancellation object that is a product or a service for which a reservation has been cancelled, a user information storing unit that stores, every user, user information and destination information related to a user in association with each other, a determining unit that determines a user corresponding to user information having a specific relation with the cancellation object in the user information storing unit as a user to which the cancellation object is recommended, and a transmitting unit that acquires destination information on the user determined by the determining unit from the user information storing unit, and transmits the information on the cancellation object to a destination according to the destination information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is an explanatory diagram of an information processing system according to a first embodiment;

FIG. 1B is a sequence diagram of information processing according to the first embodiment;

FIG. 2 is a diagram illustrating an exemplary configuration of a product providing device according to the first embodiment;

FIG. 3 is a diagram illustrating an example of a product information table;

FIG. 4 is a diagram illustrating an example of a reservation information table;

FIG. 5 is a diagram illustrating an exemplary configuration of an information providing device according to the first embodiment;

FIG. 6 is a diagram illustrating an example of a user information table;

FIG. 7 is a diagram illustrating a display example of a user information input page;

FIG. 8 is a diagram illustrating an example of a selection information table;

FIG. 9 is a diagram illustrating an example of a notification processing information table;

FIG. 10 is an explanatory diagram of a discount sale;

FIG. 11 is a flowchart of information processing in the product providing device according to the first embodiment;

FIG. 12 is a flowchart of information processing in the information providing device according to the first embodiment;

FIG. 13 is a diagram illustrating a configuration of an information providing device according to a second embodiment;

FIG. 14 is a diagram illustrating an example of a user reservation information table;

FIG. 15 and FIG. 16 are explanatory diagrams illustrating an operation of an information processing system according to the second embodiment.

### DETAILED DESCRIPTION OF THE PREFERRED EMBODIMENTS

Hereinafter, modes (hereinafter, referred to as “embodiments”) for carrying out an information providing device and an information providing method according to the present disclosure will be described in detail with reference to the accompanying drawings. An information providing device and an information providing method according to the present disclosure are not limited to the following embodiments. Further, in the following, a database is represented by DB.

### 1. First Embodiment

1.1. Information Processing System

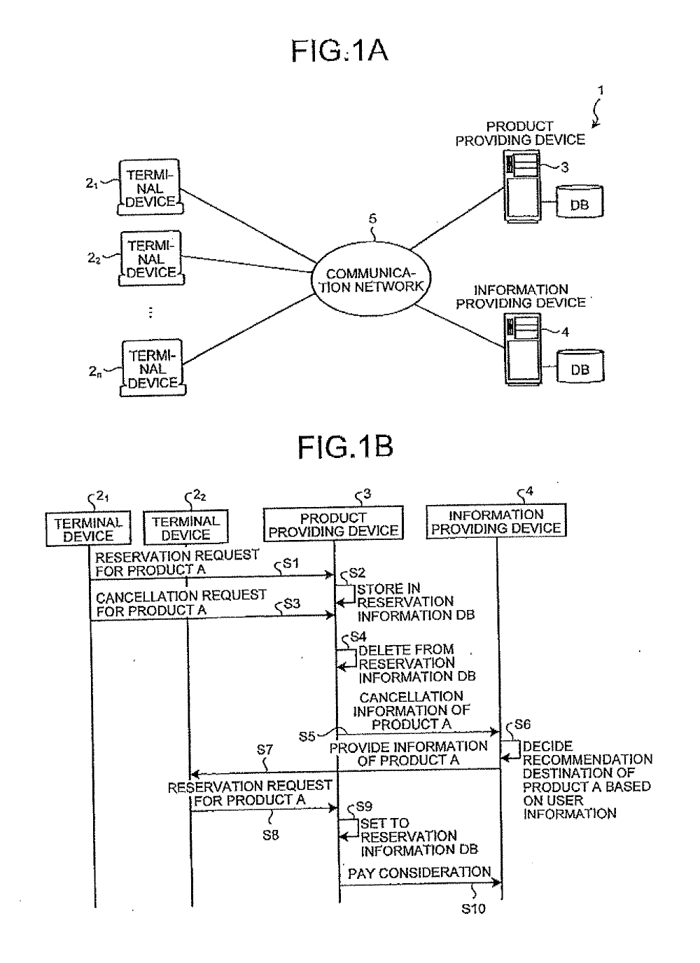

First of all, a configuration of an information processing system according to a first embodiment will be described. FIG. 1A is a diagram illustrating a configuration of the information processing system according to the first embodiment. As illustrated in FIG. 1A, an information processing system 1 according to the first embodiment includes terminal devices 2₁ to 2ₙ, a product providing device 3, and an information providing device 4, which are connected to communicate with one another via a communication network 5.

For example, the terminal devices 2₁ to 2ₙ are mobile terminals such as a mobile telephone or a smart phone or computer devices such as personal computers (PCs).

Hereinafter, when the terminal devices 2₁ to 2ₙ need not be distinguished from one another, the terminal devices 2₁ to 2ₙ are collectively referred to as a “terminal device 2.”

The product providing device 3 is a device by which a product or a service is reserved or sold. The product providing device 3 takes a purchase or a reservation for a product or a service from the terminal device 2 via the communication network 5. For example, the product providing device 3 can take a travel reservation, a restaurant reservation, a hair salon reservation, a concert or flight ticket reservation, a new product reservation, or the like.

The product providing device 3 may be a device that takes reservations for one or more products or services.

Further, the product providing device 3 may be installed at each store that provides a product or a service. Further, in the example illustrated in FIG. 1A, a single product providing device 3 is arranged in the information processing system 1, but a plurality of product providing devices 3 may be arranged in the information processing system 1.

The information providing device 4 carries out an information provision service of notifying the terminal device 2 of information on a product or a service (hereinafter, referred to as a “cancellation object”) in which a reservation is cancelled in the product providing device 3. FIG. 1B is a sequence diagram illustrating exemplary information processing according to the first embodiment, and illustrates exemplary information provision related to a product A that is a new product.

As illustrated in FIG. 1B, when a user of the terminal device 2₁ requests the product providing device 3 to take a reservation for the product A through the terminal device 2₁ via the communication network 5 (step S1), the product providing device 3 accepts the reservation for the product A from the user of the terminal device 2₁ and stores reservation information in a reservation information DB (step S2).

Thereafter, when the user of the terminal device 2₁ requests the product providing device 3 to cancel the reservation for the product A from the terminal device 2₁ via the communication network 5 (step S3), the product providing device 3 deletes the reservation information on the product A from the reservation information DB (step S4).

The product providing device 3 that has deleted the reservation information on the product A from the reservation information DB transmits cancellation information on the product A to the information providing device 4 via the communication network 5 (step S5). Upon acquiring the cancellation information on the product A from the product providing device 3, the information providing device 4 decides a user corresponding to a recommendation destination with reference to the user information DB (step S6).

The user information DB stores the user information related to the user of the terminal device 2 and the destination information in association with each other. As the user information, there is the user's attribute information (for example, a demographics attribute such as a sex, an age, and an address or a psychographics attribute representing preference, persistence or the like). Further, the destination information is information representing a destination used to give an information notification to the user of the terminal device 2 such as a mail address.

The information providing device 4 decides a user corresponding to user information having a specific relation with the product A that is a cancellation object among pieces of user information stored in the user information DB as the user corresponding to the recommendation destination. The user information having the specific relation with the cancellation object is determined based on selection criterion information stored in a product information DB. The selection criterion information is information serving as a selection criterion of a recommendation destination (selling object) of a product or a service, and stored in the product information DB in association with each product or each service.

The information providing device 4 determines a user serving as the recommendation destination of the product A of the cancellation object based on a matching degree between the selection criterion information that is stored in the product information DB and associated with the product A of the cancellation object and the user information stored in the user information DB. For example, the user corresponding to the user information in which the matching degree with the selection criterion information is a predetermined value or more is determined as the user serving as the recommendation destination of the product A.

When the recommendation destination of the product A is decided, the information providing device 4 acquires the destination information on the user serving as the recommendation destination from the user information DB, and transmits information on the product A of the cancellation object to the terminal device 2₂ of the user (step S7). Further, examples of information on the product A include a product name, a selling store name, a price, or reservation destination information on the product A, or the like.

The reservation destination information includes link information for a reservation site of the product providing device 3, and the user of the terminal device 2₂ selects the link information to request the product providing device 3 to take the reservation for the product A from the terminal device 2₂ (step S8). The product providing device 3 accepts the reservation for the product A from the user of the terminal device 2₂, and sets the reservation information on the product A to the reservation information DB (step S9).

When the user of the terminal device 2₂ completes the reservation or the purchase of the product A, the product providing device 3 performs a payment process of paying a consideration (a service usage fee) for the information provision service of the information providing device 4 (step S10). For example, the consideration is decided based on the price of the product A or the like.

As described above, in the information processing system 1 according to the first embodiment, when a reservation for a product or a service is canceled, the user corresponding to the user information having the specific relation with the cancellation object is set as the user corresponding to the recommendation destination, and the information on the cancellation object is provided to the user.

Therefore, the user who is likely to reserve a cancellation object is narrowed down and the cancellation object is recommended to the user, and thus the sale of a product or a service of a cancellation object can be promoted, and a product or a service can be appropriately provided. The information processing system 1 according to the first embodiment will be described below in further detail with reference to the accompanying drawings.

1.2. Configuration of Product Providing Device

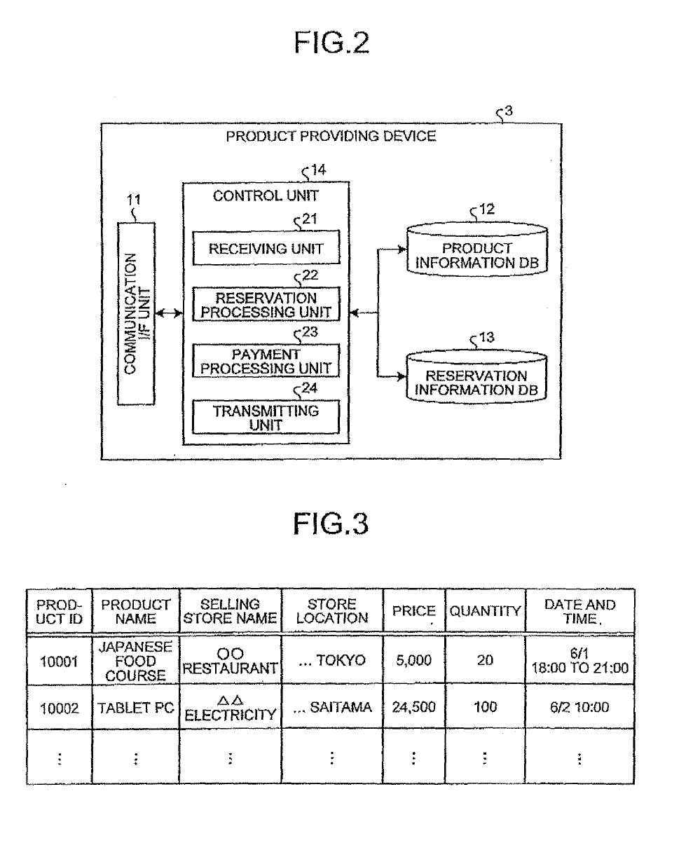

First of all, a configuration of the product providing device 3 will be concretely described. FIG. 2 is a diagram illustrating an exemplary configuration of the product providing device 3 according to the first embodiment. As illustrated in FIG. 2, the product providing device 3 includes a communication I/F unit 11, a product information DB 12, a reservation information DB 13, and a control unit 14.

The communication I/F unit 11 is a communication interface connected to the communication network 5. The control unit 14 transmits or receives various kinds of information to or from the terminal device 2 and the information providing device 4 through the communication I/F unit 11.

For example, the product information DB 12 and the reservation information DB 13 are semiconductor memory devices such as random access memories (RAMs) or flash memories or memory devices such as hard disks or optical disks.

For example, the control unit 14 is implemented by an integrated circuit such as an application specific integrated circuit (ASIC) or a field programmable gate array (FPGA). Alternatively, the control unit 14 is implemented such that, for example, a central processing unit (CPU) or a micro processing unit (MPU) executes a program stored in an internal memory device (not illustrated) using a RAM as a work area.

The control unit 14 includes a receiving unit 21, a reservation processing unit 22, a payment processing unit 23, and a transmitting unit 24, and implements or executes a function or an operation of information processing which will be described below. The configuration of the control unit 14 is not limited to the above configuration, and the control unit 14 may have a difficult configuration as long as processing which will be described below is performed.

Receiving Unit

For example, the receiving unit 21 receives a request or information from the terminal device 2 or the information providing device 4 through the communication network 5 and the communication I/F unit 11. Examples of the request from the terminal device 2 include a transmission request of a reservation page (hereinafter, referred to as a “reservation page transmission request”), a reservation request of a product or a service (hereinafter, referred to as a “reservation setting request”), and a cancellation request of a reserved product or service (hereinafter, referred to as a “reservation cancellation request”). Further, an example of the request from the information providing device 4 includes a reservation information transmission request.

Reservation Processing Unit

The reservation processing unit 22 performs processing according to the request from the terminal device 2 or the information providing device 4 when the request is received by the receiving unit 21. For example, when the reservation page transmission request is received by the receiving unit 21, the reservation processing unit 22 generates a reservation page with reference to a product information table stored in the product information DB 12 and a reservation information table stored in the reservation information DB 13.

The terminal device 2 accesses the product providing device 3 using a login ID and a password. The product providing device 3 specifies the user of the terminal device 2 (for example, a user ID) based on the login ID and the password transmitted from the terminal device 2.

Here, the product information table stored in the product information DB 12 will be described. FIG. 3 is a diagram illustrating an example of the product information table. As illustrated in FIG. 3, the product information table includes information in which pieces of information such as “product name,” “selling store name,” “store location,” “price,” “quantity,” and “date and time” are associated with one another for each “product ID.” For example, the product information table is set by the control unit 14 based on a setting request which is input from an input unit (not illustrated) in the product providing device 3 or transmitted from a store terminal to the product providing device 3.

“Product ID” is specific information assigned to each reservable product or service. “Product name” is a name of the product or the service corresponding to the product ID, and “selling store name” and “store location” are a name and a location of a store that sells the product or the service corresponding to the product ID, respectively.

“Price” and “quantity” are a sales price and a sales quantity of the product or the service corresponding to the product ID, respectively. “Date and time” is a sell-by date of the product or the service corresponding to the product ID or a provision period of time of the product or the service corresponding to the product ID.

For example, a service of a product ID “10001” is “Japanese food course” and provided at “5,000 yen” at “18:00 to 21:00 on June 1st” in “oo restaurant” located in “ . . . , Tokyo,” and the number of people to which the service can be provided is “20.”

Further, a product of a product ID “10002” is “tablet PC,” and “100” products are sold at the price of “24,500 yen” up to a sell-by date of “10:00 on June 2nd” in “A. electricity” located in “ . . . , Saitama.”

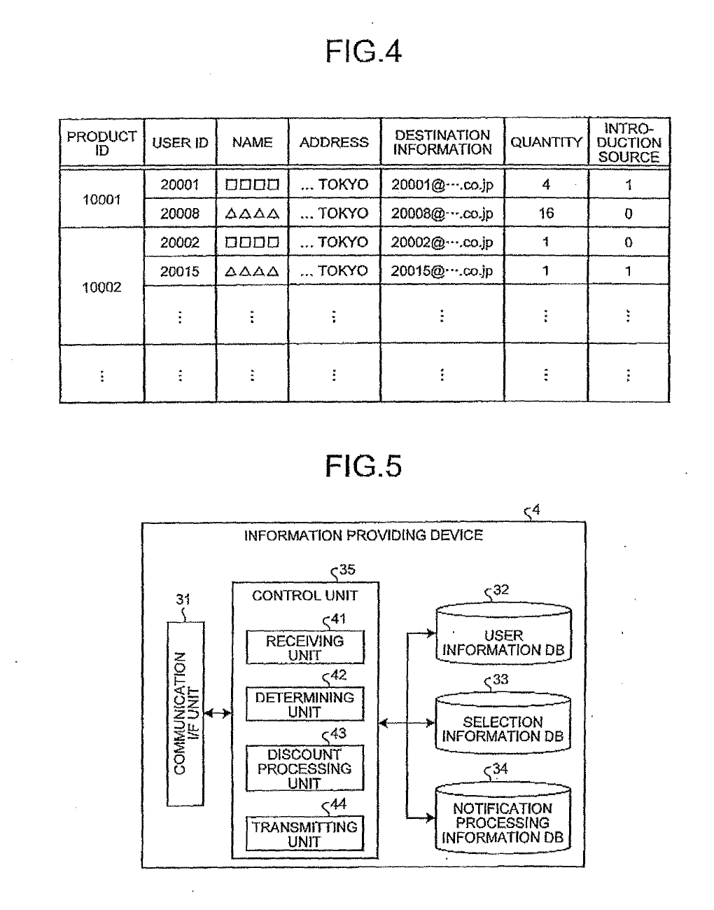

Next, the reservation information table stored in the reservation information DB 13 will be described. FIG. 4 is a diagram illustrating an example of the reservation information table. As illustrated in FIG. 4, the reservation information table includes information in which pieces of information such as “name,” “address,” “destination information,” “quantity,” and “introduction source” are associated with each “user ID” for each “product ID” associated with “user ID.” For example, the reservation information table is set by the control unit 14 based on information transmitted from the user of the terminal device 2.

“User ID” is identification information allocated to each user of the terminal device 2. The pieces of information of “name,” “address” and “destination information” are “name,” “address,” and “destination information” of the user of the terminal device 2.

“Destination information” is a destination used to give an information notification to the user of the terminal device 2, and for example, an electronic mail address, a direct mail of a social networking service (SNS), or an address of a smart phone may be set.

“Quantity” is a quantity of a product reserved by the user of the terminal device 2. For example, the example illustrated in FIG. 4 represents that a user of a user ID “20001” has reserved a service of a product ID “10001” representing “Japanese food course” corresponding to “4” people, and a user of a user ID “20002” has reserved “1” product of a product ID “10002” representing “tablet PC”.

“Introduction source” is information representing whether a reservation has been made through the information provision service of the information providing device 4, and when a reservation has been made through the information provision service of the information providing device 4, “1” is set, and otherwise, “0” is set.

For example, the example illustrated in FIG. 4 represents that the user of the user ID “20001” has reserved the service of the product ID “10001” representing “Japanese food course” through the information provision service of the information providing device 4. However, the user of the user ID “20002” has not reserved the product of the product ID “10002” representing “tablet PC” through the information provision service of the information providing device 4.

As described above, when the reservation page transmission request is received by the receiving unit 21, the reservation processing unit 22 generates a reservation page based on the product information table and the reservation information table. Specifically, the reservation processing unit 22 extracts a product ID of a product or a service for which as many reservations as a quantity is not completed in the reservation information table among products of product IDs set to the product information table.

Then, the reservation processing unit 22 generates a reservation page displaying reservation information, which includes various kinds of information such as a product name, a selling store name, a store location, a price, a remaining quantity, a sell-by date, and a provision period of time of a product or a service corresponding to the extracted product ID, for each product ID, and transmits the generated reservation page to the terminal device 2 of the request source.

For example, the product information table and the reservation information table are assumed to be in the states illustrated in FIGS. 3 and 4. In this case, for the service of the product ID “10001” representing “Japanese food course,” an upper reservation limit is “20,” a reserved quantity is “20 (=4+16),” and thus as many reservations as a quantity have been completed in the reservation information table.

Meanwhile, when the reservation for the service of the product ID “10001” representing “Japanese food course” is cancelled by the user of the user ID “20008,” the reservation information table becomes a state in which as many reservations as a quantity have not been completed.

For this reason, the reservation processing unit 22 generates a reservation page including various kinds of information such as “product name,” “selling store name,” “store location,” “price,” “quantity,” and “date and time” associated with the product ID “10001,” and transmits the generated reservation page to the terminal device 2 of the request source through the transmitting unit 24.

Upon receiving the reservation page from the product providing device 3, the control unit of the terminal device 2 causes the reservation page to be displayed on a display unit of the terminal device 2. The user of the terminal device 2 inputs information such as a name, an address, destination information, and a reservation quantity to an input field set to the reservation page, and selects, for example, a transmission button set to the reservation page. As a result, a reservation setting request is transmitted from the terminal device 2 to the product providing device 3.

The reservation setting request includes information such as a name, an address, destination information, and a reservation quantity of the user of the terminal device 2, and the reservation processing unit 22 adds the information included in the reservation setting request to the reservation information table as reservation information. A method of reserving a product or a service is not limited to a method of making a reservation using a reservation page, and a reservation setting can be made by any other method. Further, when the reservation setting request corresponds to a reservation made through the information provision service of the information providing device 4, the reservation processing unit 22 transmits the information included in the reservation setting request to the information providing device 4 as reservation setting information.

Further, a cancellation button used to cancel content reserved by the user is set to the reservation page transmitted from the product providing device 3, and when the user operates the cancellation button, the reservation cancellation request is transmitted from the terminal device 2 to the product providing device 3.

When the reservation cancellation request is received by the receiving unit 21, the reservation processing unit 22 deletes the reservation information corresponding to the reservation cancellation request from the reservation information table. For example, when the reservation information corresponding to the reservation cancellation request represents a reservation of the user ID “20001” related to the product of the product ID “10001” (see FIG. 4), the reservation processing unit 22 deletes the reservation information from the reservation information table.

Further, the reservation processing unit 22 transmits information (hereinafter, referred to as “cancellation information”) related to a product or a service for which a reservation is cancelled based on the reservation cancellation request to the information providing device 4 through the transmitting unit 24. The reservation processing unit 22 extracts information such as a product ID, a product name, a selling store name, a store location, a price, a date and time, and a quantity from the product information table and the reservation information table as the cancellation information.

For example, when the reservation information table is in the state illustrated in FIG. 4, the reservation of the user ID “20001” associated with the service of the product ID “10001” is assumed to have been cancelled. In this case, the reservation processing unit 22 extracts various kinds of information on a product name, a selling store name, a store location, a price, and a date and time corresponding to the product ID “10001” from the product information table.

Further, the reservation processing unit 22 extracts a quantity “4” corresponding to the user ID “20001” associated with the product ID “10001” on which the reservation cancellation request has been made from the reservation information table. The extracted information is transmitted to the information providing device 4 through the transmitting unit 24.

When the cancellation information is transmitted to the information providing device 4, the reservation processing unit 22 can set reservation waiting information to the reservation information table. The reservation waiting information includes information on a reservation waiting start date and time in addition to information on a product ID and a quantity corresponding to the cancellation information. When the reservation setting request is made by information provision of the information providing device 4 in connection with a product or a service corresponding to the reservation waiting information, the reservation processing unit 22 changes some or all of pieces of reservation waiting information to the reservation information according to the reservation quantity.

Payment Processing Unit

When the sale of the reserved product or service is confirmed, the payment processing unit 23 performs a payment process for the user of the terminal device 2 that has reserved the product or the service on a settlement server (not illustrated). Here, when the payment process is performed “the sale is confirmed,” but the sale may be finally decided before the payment process.

Further, when the sale of a product or a service reserved through the information provision service of the information providing device 4 is confirmed, the payment processing unit 23 executes the payment process of paying a consideration (hereinafter, a service fee) for the information provision service of the information providing device 4 to the settlement server. When “introduction source” of the reservation information table is “1,” the payment processing unit 23 determines that the product or the service has been reserved through the information provision of the information providing device 4.

The payment processing unit 23 calculates a total amount from “quantity” and “price” of the product or the service, and calculates a service fee by multiplying the total amount by a predetermined rate. For example, when a quantity is “4” and a price “5,000 yen,” “600 yen” which is “3%” of a total amount “20,000 yen” may be decided as a service fee.

Further, the payment processing unit 23 may change a rate by which a total amount is multiplied based on a period of time between a reservation waiting start date and time included in the reservation waiting information and a date and time of the product information table. For example, a rate can increase in a stepwise manner as a sell-by date approaches such that 3% is applied when the reservation waiting start date and time is three days or more before a sell-by date “10:00 on June 2nd,” 5% is applied when the reservation waiting start date and time is less than three days to one day before the sell-by date, and 10% is applied when the reservation waiting start date and time is within one day from the sell-by date in connection with the product of the product ID “10002” illustrated in FIG. 3.

Transmitting Unit

The transmitting unit 24 transmits various kinds of information such as the reservation page or the cancellation information to the terminal device 2 or the information providing device 4 through the communication I/F unit 11 and the communication network 5 as described above.

1.3. Configuration of Information Providing Device

Next, a configuration of the information providing device 4 will be described. FIG. 5 is a diagram illustrating an exemplary configuration of the information providing device 4 according to the first embodiment.

As illustrated in FIG. 5, the information providing device 4 includes a communication I/F unit 31, a user information DB 32 (an example of a user information storing unit), a selection information DB 33 (an example of a selection information storing unit), a notification processing information DB 34, and a control unit 35.

The communication I/F unit 31 is a communication interface connected to the communication network 5. The control unit 35 transmits or receives various kinds of information to or from the terminal device 2 and the product providing device 3 through the communication I/F unit 31.

For example, the user information DB 32, the selection information DB 33, and the notification processing information DB 34 are semiconductor memory devices such as RAMs or flash memories or memory devices such as hard disks or optical disks.

For example, the control unit 35 is implemented by an integrated circuit such as an ASIC or an FPGA. For example, the control unit 35 is implemented such that a CPU or an MPU executes a program (an example of an information providing program) stored in an internal memory device (not illustrated) using a RAM as a work area. For example, an information providing program can be contained to a non-transitory computer readable storage medium.

The control unit 35 includes a receiving unit 41 (an example of an information acquiring unit), a determining unit 42 (an example of a determining unit), a discount processing unit 43 (an example of a discount processing unit), and a transmitting unit 44 (an example of a transmitting unit), and implements or executes a function or an operation of information processing which will be described below.

Receiving Unit

The receiving unit 41 acquires a request or information from the terminal device 2 or the product providing device 3 through the communication network 5 and the communication I/F unit 31 For example, the receiving unit 41 receives the cancellation information transmitted from the product providing device 3 and stores the cancellation information in a cancellation information storage area of the notification processing information DB 34. The cancellation information includes information on a product or a service on which a reservation has been cancelled as described above.

Determining Unit

The determining unit 42 determines a user to which information on a cancellation object, which is a product or a service corresponding to the cancellation information, is recommended (proposed) based on the user information. Specifically, the determining unit 42 determines the user to which the information on the cancellation object is recommended based on the user information table stored in the user information DB 32 and the selection information table stored in the selection information DB 33.

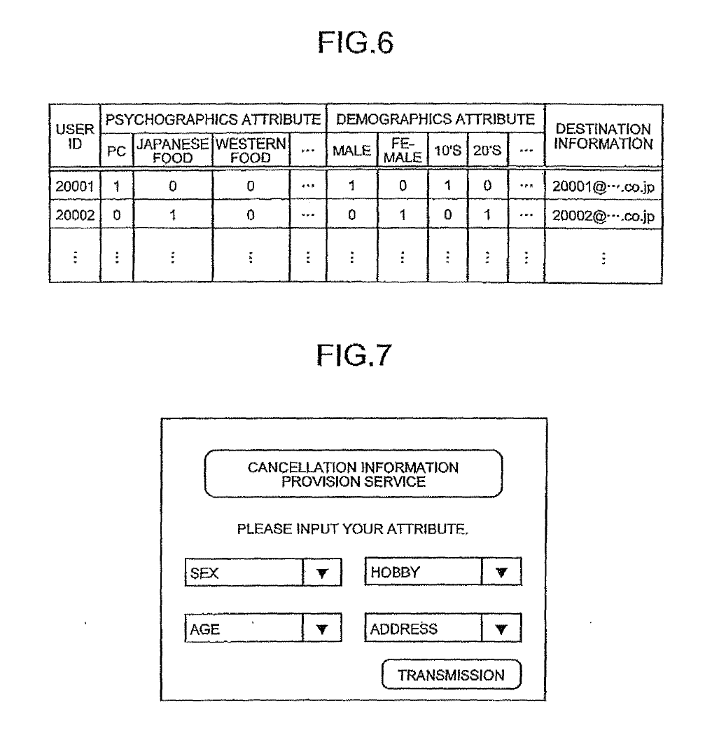

Here, the user information table will be described. FIG. 6 is a diagram illustrating an example of the user information table. As illustrated in FIG. 6, the user information table includes information in which the user information such as “psychographics attribute” and “demographics attribute” is associated with “destination information” for each “user ID.”

In the user information table illustrated in FIG. 6, “psychographics attribute” and “demographics attribute” are set as an example of the user information, but various kinds of user information can be set as will be described later.

For example, the user information table is set by the control unit 35 according to a request made from the user of the terminal device 2 to the information providing device 4. Specifically, the control unit 35 transmits information on a user information input page, which is illustrated in FIG. 7, used to cause the terminal device 2 to input the user information.

FIG. 7 is a diagram illustrating a display example of the user information input page. The user of the terminal device 2 operates an operating unit of the terminal device 2 to select a user attribute (a sex, an age, a hobby, an address, or the like) corresponding to the user through a selection box displayed on the user information input page and operate the transmission button.

As a result, the user information is transmitted to the information providing device 4, and then registered to the user information table by the control unit 35. The user information input page is used to cause the user to input information to be set to the user information table illustrated in FIG. 6, and can be variously changed according to content of the user information table.

In the user information table illustrated in FIG. 6, “user ID” is identification information allocated for each user of the terminal device 2. The user ID in the user information table is the same as or has a correspondence relation with the user ID in the reservation information table of the product providing device 3.

“Psychographics attribute” is information representing, for example, a value, a lifestyle, a personality, an interest, a preference of the user. Here, “psychographics attribute” is classified into “PC,” “Japanese food,” and “western food” as illustrated in FIG. 6.

In the example illustrated in FIG. 6, when the user's preference is relatively high, “1” is associated with each classification, and in any other case, “0” is associated. However, the present invention is not limited to this example, and for example, the user's preference may be evaluated into three or more. Further, a classification type can be variously changed.

“Demographics attribute” is a demographical attribute. Here, “demographics attribute” is classified according to a sex and an age of the user such as “male,” “female,” . . . , “10's,” “20's,” . . . as illustrated in FIG. 6.

In the example illustrated in FIG. 6, “1” is associated with a classification corresponding to the user's attribute, and in any other case, “0” is associated. In FIG. 6, the user's sex and age are illustrated as an example, but the present invention is not limited to this example, and various classification types can be used as “demographics attribute” as will be described later.

“Destination information” is a destination used to give an information notification to the user of the terminal device 2, and for example, an electronic mail address, a direct mail of an SNS, an address of a smart phone, or the like may be used.

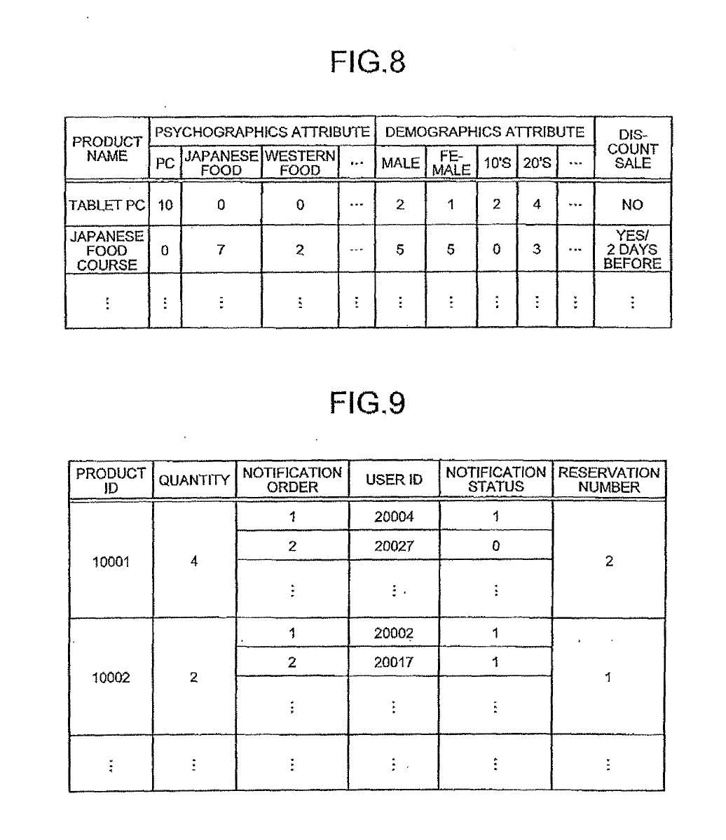

Next, the selection information table stored in the selection information DB 33 will be described. FIG. 8 is a diagram illustrating an example of the selection information table. As illustrated in FIG. 8, the selection information table includes information in which pieces of information such as “psychographics attribute,” “demographics attribute,” and “discount sale” are associated with one another for each “product name” as the selection criterion information.

“Product name” represents a name of a product or a service. Further, “psychographics attribute” and “demographics attribute” are classified in a manner similar to the user information table, and a numerical value between “0” to “10” is set to each classification. “Discount sale” includes information representing whether a product is a object of a discount sale and information representing a timing at which a discount sale is conducted.

As described above, the determining unit 42 determines the user to which the information on the cancellation object is recommended based on the user information table and the selection information table. Specifically, the determining unit 42 extracts the selection criterion information on the product or the service corresponding to the cancellation object from the selection information table, and determines the user corresponding to the user information in which the matching degree with the selection criterion information is a predetermined value or more as the user serving as the recommendation destination of the cancellation object.

For example, the user information table is assumed to be in the state illustrated in FIG. 6, the selection information table is assumed to be in the state illustrated in FIG. 8, and the cancellation object is assumed to be “tablet PC.” Further, as the user information, only “PC,” “Japanese food,” “western food,” “male,” “female,” “10's,” and “20's” are assumed to be set to the user information table.

In this case, the determining unit 42 extracts the selection criterion information corresponding to “tablet PC” from the selection information table. Pieces of selection criterion information corresponding to “tablet PC” are weighting values of the classifications such as “PC,” “Japanese food,” “western food,” “male,” “female,” “10's,” and “20's,” that is, “10,” “0,” “0,” “2,” “1,” “2,” and “4.”

As the selection criterion information, information which can be compared with the user information is desirable, and the selection criterion information can be represented simply by “1” and “0” rather than the weighting value. Further, when the weighting value is used, it is possible to more accurately determine the user that is interested in or prefers the cancellation object, but even when “1” and “0” are used as the selection criterion information rather than the weighting value, it is possible to determine the user that is interested in or prefers the cancellation object.

Next, the determining unit 42 multiplies the classification information on each piece of user information set to the user information table by the selection criterion information, and calculates a total value thereof as an evaluation value. The evaluation value represents a matching degree between the selection criterion information and the user information.

For example, in the user information table illustrated in FIG. 6, the classifications corresponding to the user ID “20001,” that is, “PC,” “Japanese food,” “western food,” “male,” “female,” “10's,” and “20's” are “1,” “0,” “0,” “1,” “0,” and “0.” Therefore, the determining unit 42 calculates “14 (=10×1+0×0+0×0+2×1+1×0+2×1+4×0)” as the evaluation value corresponding to the user ID “20001.”

Next, the determining unit 42 determines the user of the user ID corresponding to the user information in which the evaluation value is a predetermined value or more as the user serving as the recommendation destination of the cancellation object. For example, when the predetermined value is “10” and the evaluation value of the user ID “20001” is “10” or more, the determining unit 42 determines the user of the user ID “20001” as the user serving as the recommendation destination of the cancellation object.

Further, the psychographics attribute and the demographics attribute are used as the user information, but the user information is not limited to this example. For example, an address, an occupation, a family structure, an age, and an educational background of the user may be used as the user information. Further, information such as information on the user's position or place, content of a product or a service desired by the user, a period of time, place information, the user's product purchase history, the user's past product reservation status, or the user's past cancellation status may be used as the user information.

When content of a product or a service desired by the user, a period of time, place information, and information on the user's position or place are included in the user information, the user that is interested in or prefers the cancellation object can be more accurately narrowed down.

Further, when the user's past product reservation status is included in the user information, a value according to the frequency of a product reservation using the information provision service of the information providing device 4 is set as a classification of the selection criterion information. Thus, the user that is high in the frequency of a product reservation using the information provision service of the information providing device 4 can be set as the recommendation destination of the cancellation object, and a reservation for the cancellation object can be effectively made.

Further, when the user's past cancellation status is included in the user information, a value according to the cancellation frequency of a product or a service is set as a classification of the selection criterion information, and a value of the classification is set to a negative value (for example, weighted “−10”). Thus, the user who is high in the cancellation frequency can be excluded, and a reservation for the cancellation object can be appropriately made.

Next, when a plurality of users are determined as the recommendation destination, the determining unit 42 determines the ranking of the users of the recommendation destination such that the user corresponding to the user information that is high in the matching degree with the selection criterion information is high in the ranking, and sets the ranking to a notification processing information table of the notification processing information DB 34.

Here, the notification processing information table will be described. FIG. 9 is a diagram illustrating an example of the notification processing information table. As illustrated in FIG. 9, the notification processing information table includes information in which pieces of information such as “quantity,” “notification order,” “user ID,” “notification status,” and “reservation number” are associated with one another for each “product ID.”

“Product ID” is a product ID included in the cancellation information transmitted from the product providing device 3, but may be an ID corresponding to a product ID included in the cancellation information. “Quantity” is information on “quantity” included in the cancellation information.

Further, when the cancellation information on the same product ID is consecutively transmitted from the product providing device 3, the receiving unit 41 consecutively adds “quantity” included in the cancellation information to the notification processing information table. For example, when the notification processing information table is in the state illustrated in FIG. 9 and the cancellation information including the product ID “10001” and the quantity “6” is received, the receiving unit 41 changes “quantity” corresponding to the product ID “10001” in the notification processing information table to “10.”

“Notification order” is information on the ranking that the determining unit 42 allocates, like “1,” “2,” “3,” . . . , in order from the user corresponding to the user information that is high in the matching degree with the selection criterion information and high in the evaluation value. “User ID” is set to each “notification order.”

“Notification status” is information identifying whether the information on the cancellation object has been notified, and “1” is set for the user that has been notified of the information on the cancellation object, and “0” is set for the user that has not been notified of the information on the cancellation object. “Notification status” is updated each time the transmitting unit 44 transmits the information on the cancellation object.

“Reservation number” represents a number by which the user notified of the information on the cancellation object reserves or purchases the product or the service corresponding to the cancellation object through the product providing device 3. The control unit 35 sets “Reservation number” based on the reservation setting information transmitted from the product providing device 3.

The transmitting unit 44 transmits the information on the cancellation object to the user serving as the recommendation target at a notification timing based on the notification order specified in the notification processing information table. For example, the transmitting unit 44 transmits the information on the cancellation object at a notification timing in which a notification interval is a predetermined interval based on the order of the notification order.

For example, when the predetermined interval is 10 minutes, the transmitting unit 44 acquires the destination information corresponding to the user ID having the notification order of “1” from the user information table, and transmits the information on the cancellation object to the destination according to the acquired destination information. Thereafter, when 10 minutes elapse, the transmitting unit 44 acquires the destination information corresponding to the user ID having the notification order of “2” from the user information table, and transmits the information on the cancellation object to the destination according to the acquired destination information. Thereafter, similarly, the information on the cancellation object is transmitted to the destinations corresponding to the user IDs having the notification orders of “3,” “4,” . . . at intervals of 10 minutes.

Further, the transmitting unit 44 determines whether the information on the cancellation object is to be transmitted based on “quantity” and “reservation number” set to the notification processing information table. Specifically, the transmitting unit 44 does not transmit the information on the cancellation object corresponding to the same product ID that is equal in “quantity” and “reservation number.”

Further, the determining unit 42 deletes a product ID in which a predetermined time (for example, a sell-by date of a product or a service) has elapsed and information associated with the product ID from the notification processing information table. Thus, “notification status” is held in the notification processing information table until the predetermined time elapses.

Therefore, it is possible to avoid that the information on the cancellation object is notified again from one having “notification order” of “1” when the information on the same cancellation object is transmitted from the product providing device 3 before the predetermined time elapses. Further, the determining unit 42 may delete the product ID and the information associated with the product ID from the notification processing information table when equal in “quantity” and “reservation number.”

Further, the transmitting unit 44 may change a notification interval of the information on the cancellation object according to a ratio (=reservation number/quantity) between “quantity” and “reservation number.” For example, when a reference notification interval is set to “10 minutes,” quantity is “10,” and “reservation status” is “5,” the transmitting unit 44 can set the notification interval to 20 (=10×(10/5)) minutes. Further, when the ratio (=reservation number/quantity) between “quantity” and “reservation number” is a predetermined value (for example, 80%) or more, the notification interval can be set to an interval longer than the reference notification interval.

Alternatively, the determining unit 42 may perform sorting in the notification processing information table in the descending order of the evaluation values instead of information on “notification order.” In this case, the transmitting unit 44 may set the notification interval to an interval according to the difference with the evaluation value.

For example, when the difference between the already notified evaluation value of the user and the evaluation value of the user to be notified next is “13,” a time necessary until a notification is given to the next user may be set to “13 (=13×1) minutes” or “26 (=13×2) minutes.” Further, the transmitting unit 44 may set a time interval according to the evaluation value. For example, when the evaluation value is “15,” a time necessary until a notification is given to the next user may be set to “15 (=15×1) minutes” or “30 (=15×2) minutes.” As the evaluation value is used as described above, the user more appropriate as the recommendation destination can preferentially make a reservation.

Discount Processing Unit

Next, the discount processing unit 43 will be described. The discount processing unit 43 decides a discount sale based on a period of time to a sell-by date when there is a sell-by date in a cancellation object.

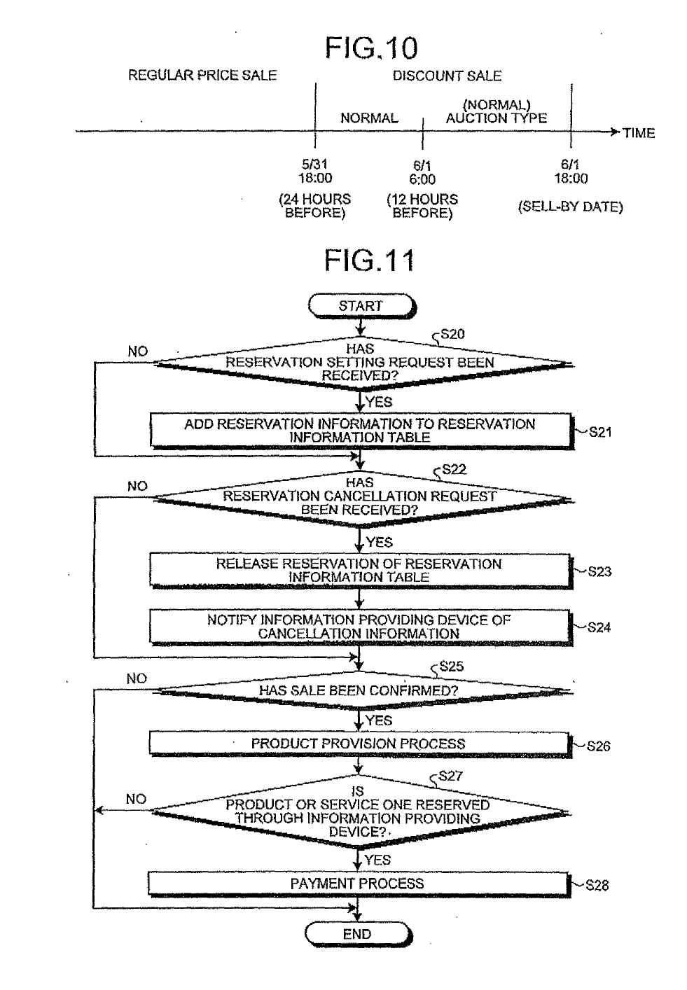

For example, the product of product ID “10001” illustrated in FIG. 3 is assumed to be the cancellation object, and the sell-by date is assumed to “18:00 on June 1st.” In this case, for example, when a present time is less than 24 hours before the sell-by date, the discount processing unit 43 may decide the product of the product ID “10001” to be on discount sale as illustrated in FIG. 10. FIG. 10 is an explanatory diagram of a discount sale.

Further, the discount processing unit 43 selects either of a normal discount sale and a discount sale of an auction type as a type of a discount sale. When the present time is 12 hours or more and less than 24 hours before the sell-by date, the discount processing unit 43 conducts the normal discount sale as illustrated in FIG. 10.

When the present time is less than 12 hours before the sell-by date and there are a plurality of users having the user information in which the evaluation value is a predetermined value or more, the discount processing unit 43 conducts the discount sale of the auction type. However, when there is a single user corresponding to the user information in which the evaluation value is the predetermined value or more, the normal discount sale is conducted.

Further a timing and a type in which a discount sale is conducted may differ according to a product or a service of the cancellation object, and in this case, an appropriate reservation according to a product or a service can be promoted.

When the normal discount sale is selected, the discount processing unit 43 decides a discount price lower than a regular price included in the cancellation information from the product providing device 3. The transmitting unit 44 notifies the user corresponding to the recommendation destination of information including the decided discount price as the information on the cancellation object.

Even when the number of users having the user information in which the evaluation value is the predetermined value or more during a normal discount sale period of time becomes two or more, the transmitting unit 44 regards the users as the recommendation destination and notifies of the information on the cancellation object at the same time regardless of the notification order. Further, the transmitting unit 44 can notify of the information on the cancellation object at the notification timing according to the notification order, and in this case, the notification interval is reduced according to a remaining time before the sell-by date.

Further, when the discount sale of the auction type is selected, the discount processing unit 43 generates information on a bidding page used to promote bidding. The transmitting unit 44 regards the user corresponding to the user information in which the evaluation value is the predetermined value or more as the recommendation destination, and notifies of the information on the bidding page generated by the discount processing unit 43 at the same time regardless of the notification order.

Thereafter, the discount processing unit 43 receives a bidding request from the terminal device 2 of the user serving as the recommendation destination through the receiving unit 41, and issues a reservation right for the cancellation object to the user suggesting the highest bid price. For example, the reservation right is issued such that information (hereinafter, referred to as “reservation right information”) of a character string described by a predetermined rule is transmitted to the terminal device 2 of the user.

The reservation right information includes the information on the cancellation object, bid price information, and bidding user information. A successful bidding user causes the reservation setting request including the reservation right information to be transmitted from the terminal device 2 to the product providing device 3, and thus makes a reservation for the cancellation object with the product providing device 3.

For example, a bidding time limit is assumed to be the sell-by date of the cancellation object or a predetermined time before the sell-by date. Further, when the bid price becomes a discount price or more in the normal discount sale, the discount processing unit 43 may end the bidding.

Further, when discount sale of the auction type is conducted by the discount processing unit 43, the determining unit 42 may reduce the predetermined value compared with the evaluation value according to a remaining time to the sell-by date and increase the number of users of the recommendation destination. As a result, the number of users participating in the auction can be increased.

Further, the above description has been made in connection with the example in which the discount processing unit 43 decides the discount sale based on a remaining time to the sell-by date, but the discount sale may be continuously conducted without being limited to the remaining time to the sell-by date.

Transmitting Unit

The transmitting unit 44 transmits various kinds of information such as the information on the cancellation object, the reservation right information, the bidding page, and the user information input page to the user corresponding to the recommendation target through the communication I/F unit 31 and the communication network 5 as described above. The transmission to the user by the transmitting unit 44 is performed based on the destination information set to the user information table.

For example, when the destination information is an electronic mail address, the transmitting unit 44 transmits a mail in which the information on the cancellation object is included in a mail text or an attached file using an electronic mail address set as the destination information as a destination address. As a result, the terminal device 2 of the user is notified of the information on the cancellation object through a mail server, a base station, or the like.

Further, when the destination information is an address of a smart phone, the transmitting unit 44 transmits the information on the cancellation object to a predetermined server using the address of the smart phone as the destination information. As a result, the terminal device 2 of the user is notified of the information on the cancellation object through a base station, or the like in a push manner.

1.4. Processing Flow of Product Providing Device

Next, a processing flow of the product providing device 3 will be described. FIG. 11 is a diagram illustrating a flowchart of information processing in the product providing device 3 according to the first embodiment. The information processing is processing repeatedly executed by the control unit 14.

As illustrated in FIG. 11, the control unit 14 determines whether the reservation setting request has been received from the terminal device 2 through the communication I/F unit 11 (step S20). When it is determined that the reservation setting request has been received (Yes in step S20), the control unit 14 adds information included in the reservation setting request to the reservation information DB 13 as the reservation information (step S21). Further when the reservation setting request is the reservation setting request using the information provision service, the control unit 14 transmits the information included in the reservation setting request to the information providing device 4 as the reservation setting information.

When it is determined in step S20 that the reservation setting request has not been received (No in step 320), the control unit 14 determines whether the reservation cancellation request has been received from the terminal device 2 through the communication I/F unit 11 (step 322). When it is determined that the reservation cancellation request has been received (Yes in step S22), the control unit 14 deletes the reservation information corresponding to the reservation cancellation request from the reservation information table (step S23). Then, the control unit 14 transmits information related to the cancellation object which is a product or a service for which a reservation has been cancelled to the information providing device 4 as the cancellation information (step S24).

When it is determined in step S22 that the reservation cancellation request has not been received (No in step S22) or when the process of step S24 ends, the control unit 14 determines whether the sale has been confirmed (step S25). When it is determined that the sale has been confirmed (Yes in step S25), the control unit 14 performs a product provision process (step S26). In the product provision process, for example, when a product is an electronic ticket, the control unit 14 performs a process of transmitting the electronic ticket to the terminal device 2 of the user, and bills the user.

When the process of step S26 ends, the control unit 14 determines whether or not a product or a service for which the sale has been confirmed is one reserved through the information provision service of the information providing device 4 (step S27). When it is determined that it is the reservation made through the information provision service (Yes in step S27), the payment processing unit 23 performs the payment process of paying a consideration for the information provision service of the information providing device 4 on the settlement server (step S28).

When it is determined in step S25 that the sale has not been confirmed (No in step S25), when it is determined in step S27 that it is not the reservation made through the information provision service (No in step S27) or when the process of step S28 ends, the control unit 14 ends the information processing illustrated in FIG. 11.

1.5. Processing Flow of Information Providing Device

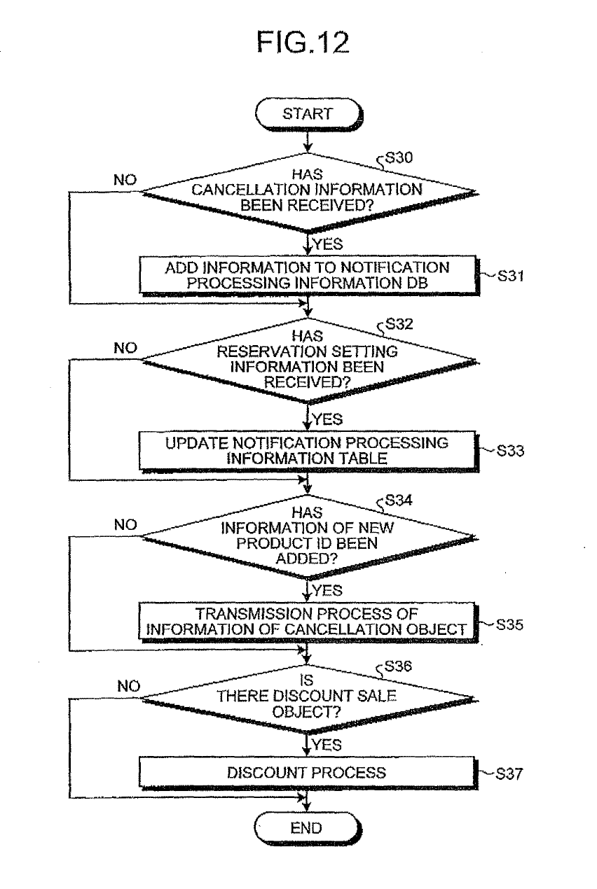

Next, a processing flow of the information providing device 4 will be described. FIG. 12 is a diagram illustrating a flowchart of information processing in the information providing device 4 according to the first embodiment. The information processing is processing repeatedly executed by the control unit 35.

As illustrated in FIG. 12, the control unit 35 determines whether the cancellation information has been received from the product providing device 3 through the communication I/F unit 31 (step S30). When it is determined that the cancellation information has been received (Yes in step S30), the control unit 35 adds the cancellation information to the notification processing information DB 34 (step S31).

When it is determined in step S30 that the cancellation information has not been received (No in step S30) or when the process of step S31 ends, the control unit 35 determines whether the reservation setting information has been received from the product providing device 3 through the communication I/F unit 31 (step S32). When it is determined that the reservation setting information has been received (Yes in step S32), the control unit 35 updates “reservation number” of the corresponding product ID in the notification processing information table based on the reservation setting information (step S33).

When it is determined in step S32 that the reservation setting information has not been received (No in step S32) or when the process of step S33 ends, the control unit 35 determines whether information on a new product ID has been added to the notification processing information DB 34 (step S34).

When it is determined that the information on the new product ID has been added (Yes in step S34), the control unit 35 performs a process of reading information on a cancellation object that is a product or a service corresponding to the new product ID from the notification processing information DB 34 and transmitting the information on the cancellation object (step S35).

For example, the process of step S35 is performed such that a user corresponding to a recommendation destination of the cancellation object is determined based on information of the user information table and the selection information table as described above, and the information on the cancellation object is transmitted to the user corresponding to the recommendation destination. Further, the control unit 35 performs a discount sale according to a sell-by date of the cancellation object as described above.

When it is determined in step S34 that the information on the new product ID has not been added (No in step S34) or when the process of step S35 ends, the control unit 35 determines whether there is a discount sale object (step S36). For example, the control unit 35 determines whether there is a cancellation object, which is within a previously set period of time before a sale period of time, set to the notification processing information table.

When it is determined in step S36 that there is a discount sale object (Yes in step S36), the control unit 35 executes the above-described discount sale process (step S37).

When it is determined that there is no discount sale object (No in step S36) or when the process of step S37 ends, the control unit 35 ends the information processing illustrated in FIG. 12.

1.6. Effects

As described above, in the information providing device 4 according to the first embodiment, the receiving unit 41 (an example of the information acquiring unit) acquires information on a cancellation object that is a product or a service for which a reservation has been cancelled, the user information DB 32 (an example of the user information storing unit) stores, every user, the user information and the destination information related to a user in association with each other, the determining unit 42 (an example of the determining unit) determines the user corresponding to the user information having the specific relation with the cancellation object among pieces of the user information stored in the user information DB 32 as the user to which the cancellation object is recommended, and the transmitting unit 44 (an example of the transmitting unit) acquires the destination information on the user determined as the recommendation destination by the determining unit 42 from the user information DB 32 and transmits the information on the cancellation object to the destination according to the destination information.

Through this operation, the information providing device 4 according to the first embodiment can narrow down, for example, the user that is interested in or prefers the cancellation object and recommend the cancellation object to the user. In other words, the cancellation object can be recommend to the user who has an intention to purchase a cancelled product or service, and thus the product or the service of the cancellation object becomes valuable, and the sale of the product or the service of the cancellation object can be promoted. Therefore, it is possible to prevent an unsold product and appropriately provide a product or a service.

In addition, in the information providing device 4 according to the first embodiment, the selection information DB 33 (an example of the selection information storing unit) stores, every product or service, a product or a service and the selection criterion information on a recommendation destination in association with each other, and the determining unit 42 determines the user serving as the recommendation destination of the cancellation target based on a matching degree between the selection criterion information that is stored in the selection information DB 33 and associated with the product or the service of the cancellation object and the user information stored in the user information DB 32.

Through this operation, the information providing device 4 according to the first embodiment can narrow down the user serving as the recommendation destination of the cancellation object with a high degree of accuracy. In other words, the cancellation object can be efficiently recommended to the user having an intention to purchase a cancelled product or service.

Furthermore, in the information providing device 4 according to the first embodiment, the determining unit 42 determines the ranking of the users corresponding to the recommendation destination such that among the users determined as the recommendation destination, the user corresponding to the user information that is high in the matching degree with the selection criterion information is high in the ranking, and the transmitting unit 44 transmits the information on the cancellation object at a notification timing according to the ranking determined by the determining unit 42.

Through this operation, the information providing device 4 according to the first embodiment can recommend the cancellation object in order from the user that is highly likely to reserve the cancellation object.

Further, in the information providing device 4 according to the first embodiment, when a sell-by date is set to a cancellation object, the discount processing unit 43 (an example of the discount processing unit) decides a discount sale based on a remaining time before the sell-by date, and when the discount sale is decided by the discount processing unit 43, the transmitting unit 44 transmits the information on the cancellation object including information on the discount sale.

Through this operation, the information providing device 4 according to the first embodiment can increase motivation to reserve a cancellation object, prevent an unsold product, and appropriately provide a product or a service.

Further, in the information providing device 4 according to the first embodiment, when there is a plurality of recommendation destinations, the discount processing unit 43 decides the sale of an auction type as the discount sale, receives a bidding request from the terminal device of the user serving as the recommendation destination, and issues a cancellation object reservation right to the user suggesting the highest bid price.

Through this operation, the information providing device 4 according to the first embodiment can increase motivation to reserve a cancellation object, prevent an unsold product, and appropriately provide a product or a service.

### 2. Second Embodiment

Next, an information processing system according to a second embodiment will be described. The information processing system according to the second embodiment partially differs from the information processing system 1 according to the first embodiment in a configuration and an operation of an information providing device. The following description will proceed with different points from the information providing device 4 according to the first embodiment. Further, in order to avoid duplicated description, components having the same function as in the first embodiment are denoted by the same reference numerals, and the descriptions thereof will not be appropriately made.

The information providing device 4 according to the first embodiment determines whether the user's preference or interest matches the cancellation object using the psychographics attribute and the demographics attribute of the user as the user information, and decides the recommendation destination of the cancellation object. However, the information providing device according to the second embodiment also determines a user that has reserved a product or a service similar to a cancellation object as the recommendation destination of the cancellation object.

2.1. Configuration of Information Providing Device

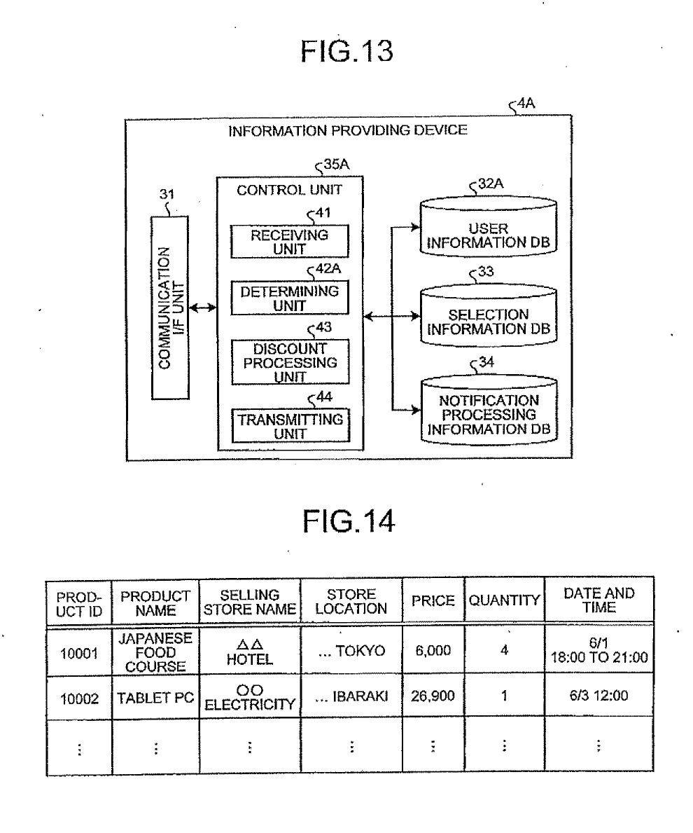

FIG. 13 is a diagram illustrating a configuration of the information providing device according to the second embodiment. As illustrated in FIG. 13, an information providing device 4A includes a communication I/F unit 31, a user information DB 32A, a selection information DB 33, a notification processing information DB 34, and a control unit 35A. The control unit 35A includes a receiving unit 41, a determining unit 42A, a discount processing unit 43, and a transmitting unit 44.

The user information DB 32A stores a user reservation information table in addition to the same user information table as in the user information DB 32 of the first embodiment as the user information. The user reservation information table is a table to which information on a product or a service reserved by the user corresponding to the user ID set to the user information table is set.

FIG. 14 is a diagram illustrating an example of the user reservation information table. As illustrated in FIG. 14, the user reservation information table includes reservation information in which pieces of information such as “product name,” “selling store name,” “store location,” “price,” “quantity,” and “date and time” are associated with one another for each “product ID.” “Product name,” “selling store name,” “store location,” “price,” “quantity,” and “date and time” in the user reservation information table are the same information as “product name,” “selling store name,” “store location,” “price,” “quantity,” and “date and time” in the product information table illustrated in FIG. 3.

When the cancellation information from the product providing device 3 is received by the receiving unit 41, the determining unit 42A determines whether a product or a service similar to a cancellation object has been set to the user reservation information table as a reserved product or service. When a reserved product or service (hereinafter, referred to as a “reserved cancellation-related object”) in which a degree of similarity with the cancellation object is a predetermined value or more has been set to the user reservation information table, the determining unit 42A determines whether there is a user corresponding to user information having a specific relation with the reserved cancellation-related object.

When the reserved cancellation-related object has been set to the user reservation information table and there is a user corresponding to user information having a specific relation with the reserved cancellation-related object, the determining unit 42A determines the user who has reserved the reserved cancellation-related object as the user serving as the recommendation destination of the cancellation object. The determination of the user information having the specific relation with the reserved cancellation-related object is performed based on the selection criterion information stored in the product information DB 12, similarly to the case of the cancellation object.

Here, the degree of similarity between the cancellation object and the reserved product or service may be determined based on a predetermined criterion, for example, in view of all degrees of similarity in a product name, a price, a store location, a date and time, or the like.

For example, a degree of similarity in a product name may be determined by performing text analysis on a product name based on morphological analysis or the like and using similarly in meaning. In this case, for example, the determining unit 42A may use a synonym DB (not illustrated) that stores synonyms such as “Japanese dish,” “Japanese restaurant,” and “Kaiseki” are associated with “Japanese food.”

Further, a degree of similarity in a price, a store location, or a date and time increases as the prices, the store locations, or the date and time are getting closer to each other. For example, the determining unit 42A adds degrees of similarity in a product name, a price, a store location, and a date and time and uses an addition result as a degree of similarity between the cancellation object and the reserved product or service. Further, a degree of similarity in a product name may be determined by setting same or similar groups in advance and using a relation with a group.

The transmitting unit 44 transmits the information on the cancellation object to the user who has reserved the reserved cancellation-related object determined as the recommendation destination by the determining unit 42A. Further, the transmitting unit 44 transmits cancellation indication information to the user corresponding to the user information having the specific relation with the reserved cancellation-related object. The cancellation indication information is information indicating that the reserved cancellation-related object is likely to be cancelled, and includes, for example, a product name, a selling store name, and a price of the reserved cancellation-related object.

Further, when the cancellation information on the reserved cancellation-related object is received by the receiving unit 41, the determining unit 42A transmits information on the reserved cancellation-related object to the user corresponding to the user information having the specific relation with the reserved cancellation-related object. For example, this information includes a product name, a selling store name, a price, reservation destination information, and the like, similarly to the information on the cancellation object. The receiving unit 41 that has received the cancellation information on the reserved cancellation-related object deletes the information on the reserved cancellation-related object from the user reservation information table.

Further, when a predetermined number or more of reserved cancellation-related objects are not set to the user reservation information table, the determining unit 42A determines the user corresponding to the user information having the specific relation with the cancellation object as the user corresponding to the recommendation destination based on the user information table so that the number of the users of the recommendation destination is a predetermined number or more, similarly to the determining unit 42. Here, the predetermined number may be set to an arbitrary value.

When the information on the cancellation object is transmitted to a plurality of recommendation destinations using the notification processing information table, the determining unit 42A may determine the ranking in the order of the user who has reserved the reserved cancellation-related object and the user corresponding to the user information having the specific relation with the cancellation object.

The transmitting unit 44 transmits a reservation information transmission request to the product providing device 3. This request is a reservation information transmission request set to the reservation information table of the reservation information DB 13 in the product providing device 3. The reservation information transmitted from the product providing device 3 according to the transmission request is received by the receiving unit 41 and set to the user reservation information table.

Further, the transmitting unit 44 may request the product providing device 3 to determine a reserved product or service in which a degree of similarity with the cancellation object is a predetermined value or more. In this case, the product providing device 3 determines a reserved product or service in which a degree of similarity with the cancellation object is a predetermined value or more according to the request from the information processing system, and transmits the result to the information processing system.

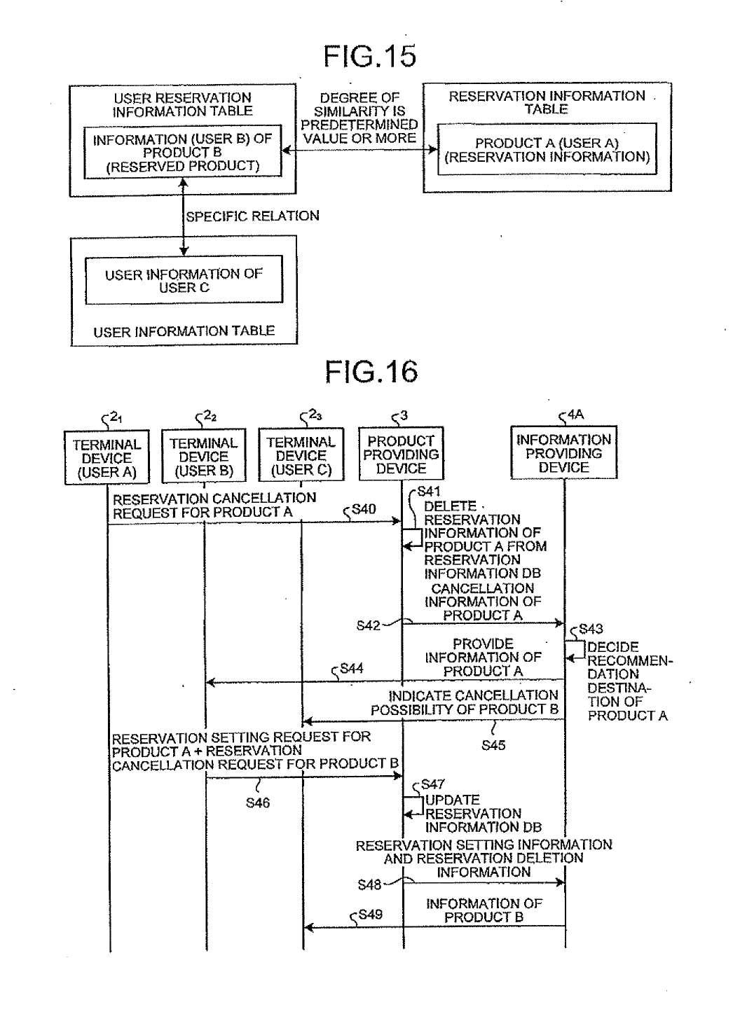

Here, an exemplary operation of the information processing system according to the second embodiment will be described with reference to FIGS. 15 and 16. FIGS. 15 and 16 are explanatory diagrams illustrating an operation of the information processing system according to the second embodiment.

As illustrated in FIG. 15, information on a product A reserved by a user A is set to the reservation information table, and a product B in which a degree of similarity with the product A is a predetermined value or more is set to the user reservation information table as a product reserved by a user B. Further, user information having a specific relation with the product B is set to the user information table, and a user corresponding to the user information is assumed to be a user C. Here, the number of the recommendation destinations of the cancellation object is assumed to be one.

In this state, as illustrated in FIG. 16, when a reservation cancellation request of the product A is transmitted from the terminal device 2₁ of the user A (step S40), the control unit 14 of the product providing device 3 deletes the reservation information on the product A for the user corresponding to the terminal device 2₁ from the reservation information DB 13 (step S41).

When the reservation information on the product A is deleted from the reservation information DB 13, the control unit 14 of the product providing device 3 transmits the cancellation information on the product A to the information providing device 4A through the communication network 5 (step S42). The cancellation information includes information on the product A for which the reservation has been cancelled by the user A of the terminal device 2₁.

Upon acquiring the cancellation information on the product A from the product providing device 3, the control unit 35A of the information providing device 4A decides the user serving as the recommendation destination of the cancellation object (step S43). In this process, when there is a user corresponding to user information having a specific relation with a reserved cancellation-related object in which a degree of similarity with the product A serving as the cancellation object is a predetermined value or more, the control unit 35A of the information providing device 4A determines the user corresponding to the reserved cancellation-related object as the user serving as the recommendation destination of the cancellation object.

However, when there is no reserved cancellation-related object or when there is no user information having the specific relation with the reserved cancellation-related object, the determining unit 42A decides the user corresponding to the user information having the specific relation with the cancellation object as the user serving as the recommendation destination of the cancellation object, similarly to the determining unit 42.

Further, when a predetermined number or more of recommendation destinations are necessary, the determining unit 42A decides the user serving as the recommendation destination of the cancellation object in the order of the user who has reserved the reserved cancellation-related object and the user corresponding to the user information having the specific relation with the cancellation object as described above.

Here, due to the relation illustrated in FIG. 15, the determining unit 42A decides the user B as the recommendation destination of the product A. When the recommendation destination of the product A is decided, the control unit 35A of the information providing device 4A transmits information on the product A serving as the cancellation object to the terminal device 2₂ of the user B serving as the recommendation destination (step S44). Examples of the information on the product A include a product name, a selling store name, a price, and reservation destination information on the product A.

Further, the control unit 35A of the information providing device 4A decides the user C of the user information having a specific relation with the reserved cancellation-related object as the user corresponding to the recommendation destination of the reserved cancellation-related object based on the user reservation information table. Then, the control unit 35A transmits the cancellation indication information on the product B serving as the reserved cancellation-related object to the terminal device 2₃ of the user C serving as the recommendation destination of the reserved cancellation-related object (step S45).

Thereafter, when a request including a reservation setting request for the product A and a reservation cancellation request for the product B is transmitted from the terminal device 2₂ that has received the information on the product A (step S46), the control unit 14 of the product providing device 3 updates the reservation information DB 13 (step S47). Specifically, the control unit 14 deletes the reservation information on the product B corresponding to the user B from the user reservation information table, and sets the reservation information on the product A corresponding to the user B to the user reservation information table.

The control unit 14 of the product providing device 3 transmits information including the reservation setting information and the reservation deletion information to the information providing device 4A (step S48). The reservation setting information includes information representing that the reservation information on the product A has been set to the user reservation information table, and the reservation deletion information includes information representing that the reservation information on the product B has been deleted from the reservation information table.

Upon receiving the reservation deletion information on the product B, the control unit 35A of the information providing device 4A transmits the information on the product B serving as the cancellation object to the terminal device 2₃ of the user C that has transmitted the cancellation indication information (step S49). As a result, the user C is encouraged to reserve the product B.

In the above example, when there is a user corresponding to user information having a specific relation with a reserved cancellation-related object, the user who has reserved the reserved cancellation-related object is set as the recommendation destination, but even when there is no user corresponding to user information having a specific relation with a reserved cancellation-related object, the user who has reserved the reserved cancellation-related object can be set as the recommendation destination.

Meanwhile, there are cases in which a provider that provides a reserved product or service desires to cancel a reservation for some products or services. For example, let us assume that there is a provider that provides a lodging service capable of accommodating 100 people. For example, there are cases in which when there is a reservation request for 100 people in a state in which a reservation for 10 people has been made, the provider desires to cancel a reservation for 10 people that has been already accepted.

In this case, reservation information desired to be cancelled is set to the user reservation information table of the information providing device 4A, and thus reservation cancellation can be encouraged. Further, when a provider that provides a product or a service desires to cancel a reservation and a corresponding reservation is cancelled as described above, a consideration may be paid from the provider providing a product or a service to the provider of the information providing device 4A by a payment process or the like.

Further, the reservation information set to the user reservation information table may be acquired, for example, from the reservation information table set to the reservation information DB 13 of the product providing device 3 as described above rather than the reservation information transmitted from a device of a provider desiring to cancel a reservation.

2.2. Effects

In the information providing device 4A according to the second embodiment, in addition to the information providing device 4 according to the first embodiment, the user information includes information on a product or a service reserved by the user, and when there is a reserved product or service in which a degree of similarity with a cancellation object is a predetermined value or more among reserved products or services stored in the user information DB 32A, the determining unit 42A determines a user corresponding to the reserved product or service as the user serving as the recommendation destination of the cancellation object.

Through this operation, the information providing device 4A according to the second embodiment sets the user who has reserved the product or the service related to the cancellation object as the recommendation destination. Thus, when the cancellation object is better than the reserved product or service, the user's choices can be increased, attraction of the information provision service provided by the information providing device 4A can be improved, and participation in the information provision service can be encouraged.

Further, in the information providing device 4A according to the second embodiment, in addition to the information providing device 4 according to the first embodiment, when there is a user corresponding to user information having a specific relation with a reserved product or service in which a degree of similarity with a cancellation object is a predetermined value or more, the determining unit 42A determines the user who has reserved the reserved product or service as the user serving as the recommendation destination of the cancellation object.

Through this operation, in the information providing device 4A according to the second embodiment, even when the reserved product or service is cancelled, the sale of the product or the service can be promoted, an unsold product can be prevented, and a product or a service can be appropriately provided.

Furthermore, in the information providing device 4A according to the second embodiment, in addition to the information providing device 4 according to the first embodiment, when a reserved product or service related to a cancellation object is cancelled, the determining unit 42A determines a user corresponding to user information having a specific relation with the reserved product or service as the user serving as the recommendation destination of the reserved product or service, and when a reserved product or service in which a degree of similarity with a cancellation object is a predetermined value or more is cancelled, the transmitting unit 44 acquires destination information on the user determined as the recommendation destination of the product or service for which the reservation has been cancelled from the user information DB 32A, and transmits information on the product or service for which the reservation has been cancelled to a destination according to the destination information.

Through this operation, in the information providing device 4A according to the second embodiment, even when a reserved product or service is cancelled, the sale of the product or the service can be promoted, an unsold product can be prevented, and a product or a service can be appropriately provided.

### 3. Modification

In the information processing system, the product providing device 3 and the information providing devices 4 and 4A have been separately described, but the function of the product providing device 3 can be incorporated into the information providing devices 4 and 4A.

Further, in the above-described information processing system, link information on the product providing device 3 is included in the information on the cancellation object or the information on the reserved cancellation-related object, but link information of the information providing devices 4 and 4A may be also included. In this case, the reservation setting request is transmitted from the terminal device 2 to the product providing device 3 through the information providing devices 4 and 4A.

According to an embodiment, it is possible to provide an information providing device, an information providing method, and an information providing program, which are capable of appropriately providing a product or a service.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information providing device, comprising:
an information acquiring unit that acquires information on a cancellation object that is a product or a service for which a reservation has been cancelled;
a user information storing unit that stores, every user, user information and destination information related to a user in association with each other;
a determining unit that determines a user corresponding to user information having a specific relation with the cancellation object in the user information storing unit as a user to which the cancellation object is recommended; and
a transmitting unit that acquires destination information on the user determined by the determining unit from the user information storing unit, and transmits the information on the cancellation object to a destination according to the destination information.

2. The information providing device according to claim 1, further comprising,
a selection information storing unit that stores, every product or service, selection criterion information on a recommendation destination in association with a product or a service,
wherein the determining unit determines the user to which the cancellation object is recommended based on the selection criterion information that is stored in the selection information storing unit and associated with the product or the service of the cancellation object and a matching degree with the user information stored in the user information storing unit.

3. The information providing device according to claim 2,
wherein the determining unit determines a ranking of a user to-be recommended such that among users to be recommended, a user corresponding to user information that is high in a matching degree with the selection criterion information is high in ranking, and
the transmitting unit transmits the information on the cancellation object at a notification timing according to the ranking determined by the determining unit.

4. The information providing device according to claim 1,
wherein the user information includes information on a product or a service reserved by the user, and
when there is a reserved product or service in which the degree of similarity with the cancellation object is a predetermined value or more among reserved products or services stored in the user information storing unit, and there is a user corresponding to user information having a specific relation with the reserved product or service, the determining unit determines the user corresponding to the reserved product or service as the user to be recommended instead of or together with the user corresponding to the user information having the specific relation with the cancellation object.

5. The information providing device according to claim 1,
wherein the user information includes information on a product or a service reserved by the user, and
the determining unit determines a user corresponding to a reserved product or service in which the degree of similarity with the cancellation object is a predetermined value or more among reserved products or services stored in the user information storing unit as the user serving to be recommended.

6. The information providing device according to claim 5,
wherein when there is a user corresponding to user information having a specific relation with the reserved product or service in which the degree of similarity with the cancellation object is a predetermined value or more, the determining unit determines the user who has reserved the reserved product or service as the user to be recommended.

7. The information providing device according to claim 4,
wherein when the reserved product or service related to the cancellation object is cancelled, the determining unit determines a user corresponding to user information having a specific relation with the reserved product or service as a user to be recommended, and
when the reserved product or service in which the degree of similarity with the cancellation object is a predetermined value or more is cancelled, the transmitting unit acquires destination information on the user determined as the recommendation destination of the reserved product or service for which the reservation has been cancelled from the user information storing unit, and transmits information on the product or service for which the reservation has been cancelled to a destination according to the destination information.

8. The information providing device according to claim 5,
wherein when the reserved product or service related to the cancellation object is cancelled, the determining unit determines a user corresponding to user information having a specific relation with the reserved product or service as a user to be recommended, and
when the reserved product or service in which the degree of similarity with the cancellation object is a predetermined value or more is cancelled, the transmitting unit acquires destination information on the user determined as the recommendation destination of the reserved product or service for which the reservation has been cancelled from the user information storing unit, and transmits information on the product or service for which the reservation has been cancelled to a destination according to the destination information.

9. The information providing device according to claim 1, further comprising,
a discount processing unit that decides a discount sale based on a period of time before a sell-by date when the sell-by date is set to the cancellation object,
wherein the transmitting unit transmits the information on the cancellation object including information on the discount sale when the discount sale is decided by the discount processing unit.

10. The information providing device according to claim 9,
wherein when there are a plurality of recommendation destinations, the discount processing unit decides a sale of an auction type as the discount sale, receives a bidding request from a terminal device of the user to be recommended, and issues a reservation right of the cancellation object to a user suggesting a highest bid price.

11. An information providing method executed by a computer, comprising:
acquiring information on a cancellation object that is a product or a service for which a reservation has been cancelled;
determining a user corresponding to user information having a specific relation with the cancellation object in a user information storing unit that stores, every user, user information and destination information related to a user in association with each other as a user to which the cancellation object is recommended; and
acquiring destination information on the user to be recommended from the user information storing unit, and
transmitting the information on the cancellation object to a destination according to the destination information.

12. A non-transitory computer readable storage medium containing program instructions for providing information, wherein execution of the program instructions by one or more processors of a computer system causes the one or more processors to perform:
acquiring information on a cancellation object that is a product or a service for which a reservation has been cancelled;
determining a user corresponding to user information having a specific relation with the cancellation object in a user information storing unit that stores, every user, user information and destination information related to a user in association with each other as a user to which the cancellation object is recommended; and
acquiring destination information on the user to be recommended from the user information storing unit, and
transmitting the information on the cancellation object to a destination according to the destination information.
